(19) United States
(12) Patent Application Publication
(10) Pub. No.: US 2013/0232106 A1
(43) Pub. Date: Sep. 5, 2013

(54) System and Method For Applying An Update To A Database

(71) Applicants: Manish Shah, Hillborough, NJ (US); Sachindatta Dhamane, Hackettstown, NJ (US)

(72) Inventors: Manish Shah, Hillborough, NJ (US); Sachindatta Dhamane, Hackettstown, NJ (US)

(73) Assignee: Cover-All Technologies, Inc., Fairfield, NJ (US)

(21) Appl. No.: 13/410,163

(22) Filed: Mar. 1, 2012

(51) Int. Cl. G06F 17/30

(52) U.S. Cl. 707/609; 707/E17.005

(57) ABSTRACT

A computer-implemented method for updating multiple data records in a database in a single transaction. The method includes searching a data model associated with the data records in the database for fields related to an objective. Once complete, a user will enter new objective values associated with the objective. The processor then performs a business rule validation of the fields found during the searching step with the new objective values entered. The report is then displayed to a user on a display. The user reviews the report and may approve the new objective values. If approved, the finalized objective values are applied to the database.

### BACKGROUND

There are many approaches a software designer may take when designing a system for managing a database. During the designing phase, the programmer may take into account, among other things, the type of data that will be stored in the database, the users who are going to being accessing the data, the tasks the user may perform and the software applications that may analyze and/or update the database. For example, in the context of the insurance industry, the programmer may take into account the complexities of an insurance policy such as the entities associated with the policy, the different type of insurance products and the ever changing business rules affecting the policies.

Commercial insurance policies are usually used by large corporations or businesses and cover multiple aspects of the insurance industry such as professional liability coverage, general errors and omissions coverage, property and casualty protection coverage (“property coverage”), worker's compensation, and other types of insurance products that would protect their business interests. When populating a database with these large policies many difficulties may arise due to the fact that these commercial policies are highly complex and may involve a large number of entities and organizations, e.g., insurance carriers, underwriters, government regulatory agencies, brokers, agents, administrators, and insured entities. Each of these entities can have significant input into the substance of an insurance policy.

Additionally, these commercial policies usually are created in a pre-approved manner using a set of business rules (rules created by the entities during formation of the policy). When an entity wants to modify a portion of an existing policy (such as, an insured wishing to increase liability coverage, or an administrator wishing to add additional coverage to a policy), the task of making a simple change in a large policy becomes extremely difficult. Difficultly arises because these simple changes potentially trigger multiple business rules and the change most likely needs to be updated in more than one location within the database. Up until now, policy management systems will only accept a single update at a time. In small personal policies, most changes usually only need to be performed on a single field within the database. But when making a simple change in a commercial policy, the simple change may affect multiple fields within the policy. In order to make this change, a user of the system must search through large amounts of data sets which contain repeating data elements to find where the change is to take place and then apply the business rules that apply to this change. This process is very tedious, time consuming and produces a large amount of human error.

### SUMMARY OF THE DISCLOSED TECHNOLOGY

The disclosed technology is related to the processing of single transactions involving one or more common changes across multiple business objects in a database. An implementation of this invention may automatically adapt itself to any changes made in the underlying business objects, fields of the business objects, data within the field and/or addition, deletion or modification of the business rules. The implementation may also be controlled by security and may maintain a full audit trail of operations performed so that the changes may revert back to the original, completely or partially.

In a first aspect, a computer-implemented method may update multiple data records in a database in a single transaction. The method includes searching a data model associated with the data records in the database for fields related to an objective. The objective may be a request to update the data model with a transaction involving at least one modification, the data model being a hierarchical database model that may contain repeating data elements. The search is performed via a query of the data model using the objective.

Once the search is complete, a user interface may be provided to search through the fields found during the searching step so that a user may adjust the fields as needed. Once adjusted by the user, the user may enter new objective values associated with the objective. A processor may then perform a full validation of the fields found during the searching step with the new objective values entered. The full validation includes applying business rules and/or field validation rules to the fields found during the searching step with the new objective values entered. The processor will display the full validation as a report to a user. The report may include the fields found during the searching step, the new objective values, previous objective values, and business rules violations, if any. The user may then review the report and may (1) approve the new objective values, (2) rectify any business rule violations by modifying the new objective value into an objective value that does cause a business rule violation, or (3) exclude fields a user does not want mass update. If approved, the finalized objective values are then applied to the database and an audit trail is created.

The audit trail is created so that changes may be reverted completely or partially. That is, if the user decides the updated values are not correct, the user may revert selected fields to original values using the audit trail.

In a second aspect, a system for analyzing and updating data records in a database is presented. The system may include one or more processors and one or more computer-readable storage mediums containing instructions configured to cause the one or more processors to perform operations. The operations may include: searching a data model for fields related to an objective, the searching step performing a query of the data model using the objective, the objective being a request to update the data model with a transaction involving at least one modification for one or more fields; entering new objective values that are associated with the objective; performing a full validation of the fields found during searching step with the new objective values entered, the full validation includes applying business rules to the fields found during searching step with the new objective values entered; displaying a report of the full validation on a display; approving the new objective values, the report includes the fields found during the searching step, the new objective values, previous objective values, and business rules violations, if any; and applying the finalized objective values to the data model.

In a third aspect, a computer-program product, tangibly embodied in a machine-readable storage medium, including instructions configured to cause a data processing apparatus, is presented. The product may be capable of searching a data model for fields related to an objective. In the searching step, the processing apparatus performs a query of the data model using the objective, the objective being a request to update the data model with a transaction involving at least one modification across at least two fields. The processing apparatus accepts new objective values that are associated with the objective and performs a full validation of the fields found during searching step with the new objective values entered. The full validation includes applying business rules to the fields found during searching step with the new objective values entered. The processing apparatus then displays a report of the full validation, the report may include the fields found during the searching step, the new objective values, previous objective values, and business rules violations, if any. If the new values are accepted, the processing apparatus applies the finalized objective values to the data model.

### BRIEF DESCRIPTION OF THE DRAWINGS

FIG. 1 is a block diagram showing an embodiment of the disclosed technology;

FIG. 2 is a hierarchical data model for an insurance product used with the disclosed technology;

FIGS. 3a-e are a set of flow charts showing the disclosed technology; and

FIGS. 4-10 are screen captures for an embodiment of the disclosed technology.

### DETAILED DESCRIPTION

A database management system (DBMS) is a software package with computer programs that control the creation, maintenance, and use of a database. It allows organizations to conveniently develop databases for various applications by database administrators and other specialists.

Databases used by the DBMS are typically an integrated collection of data records, files, and other objects. A DBMS allows different user application programs to concurrently access the database. DBMSs may use a variety of database models, such as the relational model or object model, to conveniently describe and support applications. A specific type of object model is a hierarchical database model. The hierarchical database model is a data model in which the data is organized into a family tree-like structure. The structure uses parent/child relationships to represent the information with each parent capable of having many children, but each child has only one parent (also known as a “1-to-many” relationship). In a complex database, the relational database model may be further constructed so that one part of a family tree may point to another part of the family tree. This type of complex structure is known as a “many-to-many” relationship.

A DBMS may also support query languages. A database query language allows users to interactively interrogate the database, analyze its data and update it according to the user's privileges. Database languages also simplify the database organization as well as retrieving and presenting information from it. A DBMS may also provide facilities for controlling data access, enforcing data integrity, managing concurrency control, and recovering the database after failures and restoring it from backup files, as well as maintaining database security.

The DBMS may also provide a way to interactively enter and update the database, as well as interrogate it. DBMS's usually do not leave an audit trail of actions or provide the kinds of controls necessary in a multi-user organization. These controls are only available when a set of application programs are customized for each data entry and updating function.

In order to describe the functionality of the disclosed technology, we will use commercial insurance policies as an example of populating the DBMS but the invention is not limited to the insurance industry.

In the insurance industry, it was found that users of a typical database management system need a system with the ability to: search the records to be updated using any information available on specific business objects or any child thereof, update the specific fields based on the business object or any child thereof, and/or perform full validation of concerned fields to ensure business rules and filed validation rules are enforced. The problem with existing systems is that when performing these actions across multiple business objects in an integrated policy a user must perform each update and apply each business rule separately.

The disclosed technology overcomes the inefficiencies of previous database management systems in that the disclosed technology allows the processing of a single transaction that involves one or more changes across multiple business objects in one process. This feature was needed because the nature of insurance products constantly requires the addition of new business objects, the addition of new fields to existing business objects, and updating business rules to keep the system relevant and current with the always changing business world.

Data capture for insurance policies, especially commercial lines, involves inputting policy characteristics or business objects that appear multiple times into a hierarchical database. These policy characteristics can include financial characteristics (e.g., ratings and quotes), organization-based characteristics (e.g., data relating to the organization holding the policy), contract-based information (e.g., terms and conditions relating to particular policies), and business rules (e.g., data relating to the policy characteristics). These policy characteristics are stored within a memory device of the database management system and may have zero or more repeating child data elements themselves.

Additionally, each policy characteristic may be associated with a business rule or field validation rule. For example, a business rule may be dependent on policy location (e.g., the city or state where the policy is in effect) or may enforce an entity created rule (e.g., rate cannot be below certain dollar amount). Field validation rules apply to the updateable status of a field, e.g., individual fields of data can be fully accessible and updateable while other fields are read-only and still other fields may be kept from view for a particular entity in a particular context given a particular business rule.

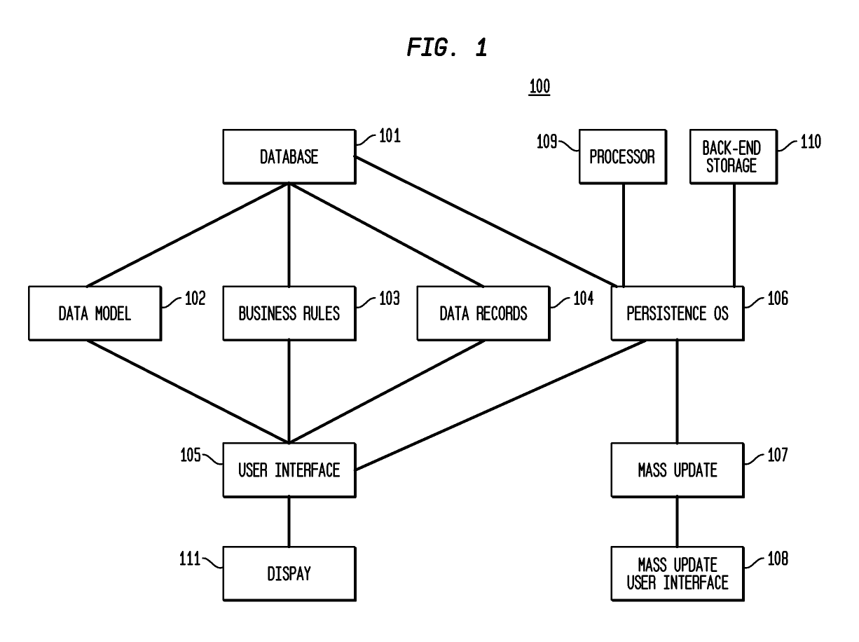

FIG. 1 is a block diagram showing a database management system 100 illustrating the interconnection between various components. The system 100 may include a database 101 having a data model 102, a business rules database 103 and data records 104, a persistence operating system 106, a system user interface 105, display 111, a mass update module 107 and a mass update interface 108.

The data model 102 describes business objects and their relationships with each other. For example, the database model 102 may be a hierarchical database model which organizes the data into a family tree-like structure. The structure allows representing information using parent/child relationships: each parent can have many children, but each child has only one parent (also known as a 1-to-many relationship). All attributes of a specific record are listed under an entity type.

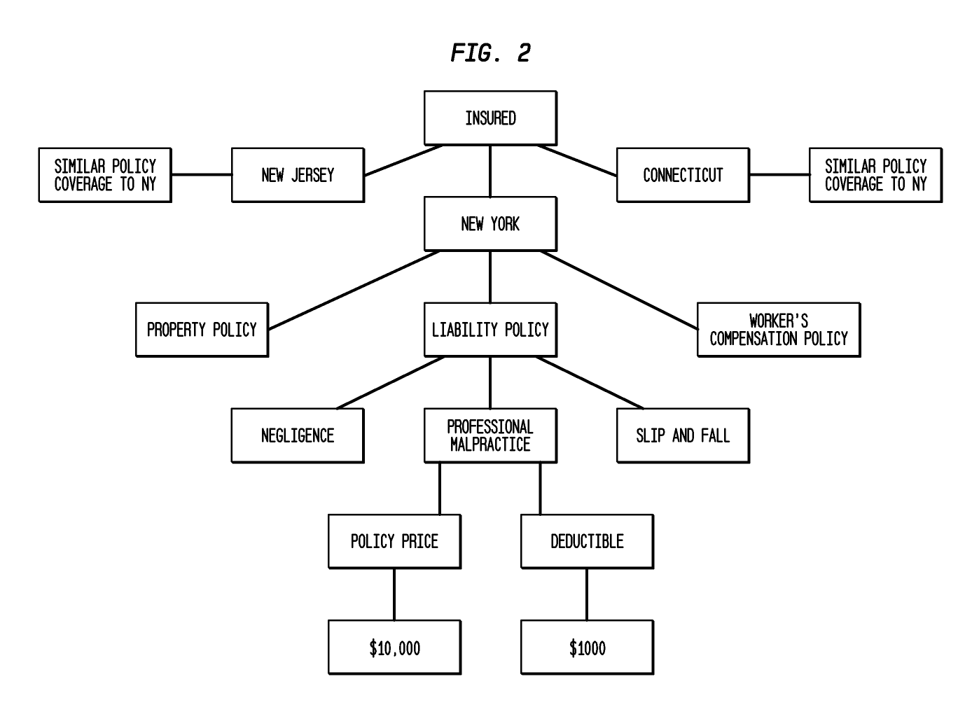

FIG. 2 is the sample of a database model 102 describing an integrated insurance policy. This example is of a simple data model for purposes of explaining the disclosed technology. In a real world application the data model will typically be more complex.

As shown in FIG. 2 an insured takes out an integrated policy that covers liability in multiple states. The policy covers New Jersey, New York and Connecticut. Each of these states have their own policy coverage rules for property, liability and worker's compensation with business rules being applied differently in each state. As shown, the liability policy may be broken into smaller policies relating to negligence, professional malpractice and slip and fall. The professional malpractice may then be broken down into the cost of the policy and the deductible for the policy.

The business rules database 103 describes the validations on the fields of the business objects. For example, often one wants to apply rules to attributes so that the attributes are clean and reliable. For example, we may have a rule that says in the state of New York the malpractice deductible cannot be lower than $800. If somebody tries to change the deductible to a number below $800, we want the DBMS to deny such a request and display an error message. However, rules may need to change over time. Ideally such rules should be able to be added and removed as needed without significant data layout redesign.

The system 100 processes the data using a persistence operating system 106 that works with a processor 109 and a back-end data storage device 110. The four basic functions of persistent operating system 106 are to create, read, update and delete the persistent storage. It may also be used with a user interface 105 to facilitate viewing, searching, and changing information located on a storage medium and may be used to make computer-based forms and reports.

A user interface 105 that works with all these aforementioned components presents the data model to the user for data entry, enforcement of business rules and storing the data.

Mass update module 107 and mass update user interface 108 allows the processing of transactions involving one or more common changes across multiple business objects and will be described in greater detail below. More specifically, the mass update module 107 will search the data model 102 for all fields related to a modification objective. The mass update module 107 allows a user to enter new modification objective values into fields related to the modification objective. The mass update module will then perform a full validation of fields related to the new modification objective values to ensure all relevant business rules are enforced. This includes, among other things, allowing the mass update module 107 to take into account user interface rules that ensure UI validations are enforced, e.g., no updating disabled fields or fields not available because of security. Once completed, the system will display a report of the full validation. This report may include the fields related to the modification objective, the new modification objective values, previous modification objective values fields, and business rules violations, if any. Once accepted by the user, the new modification objective values may be finalized and applied to the data model.

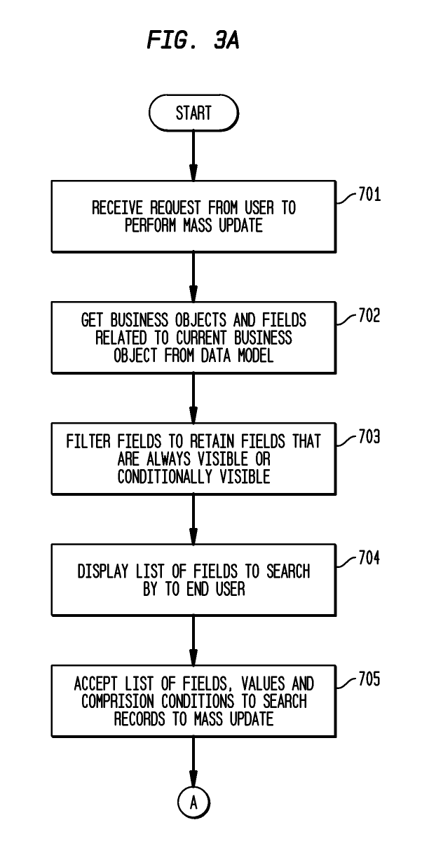

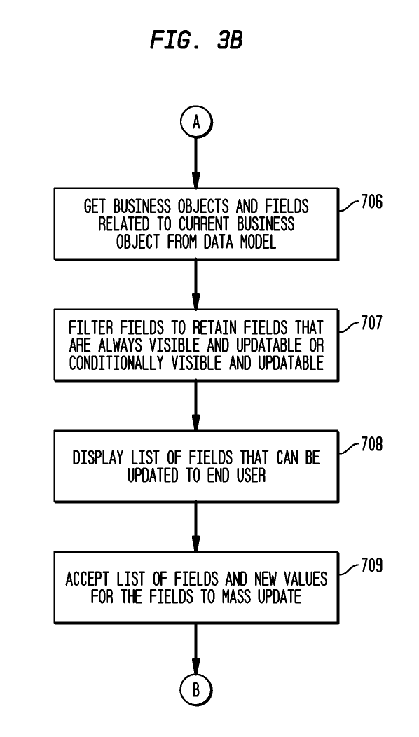

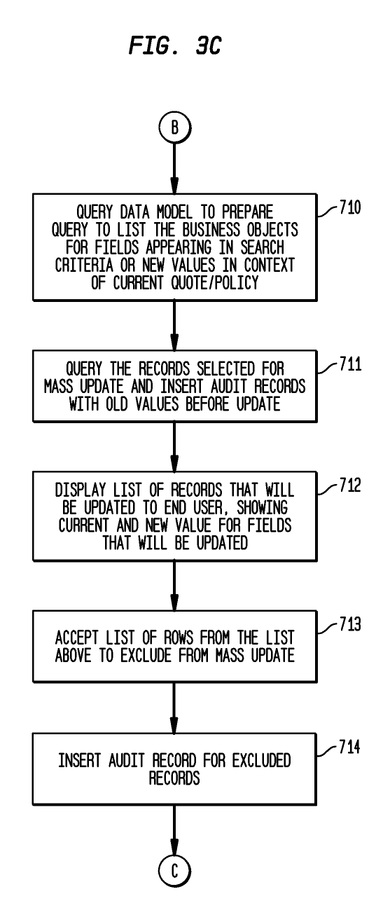

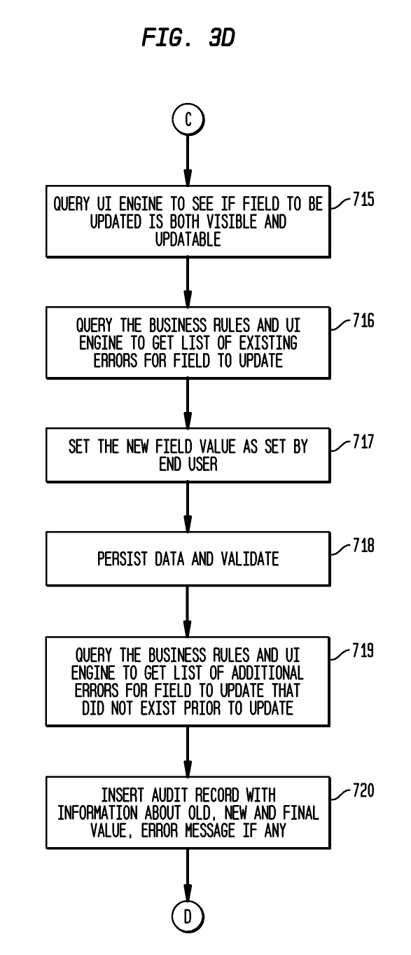

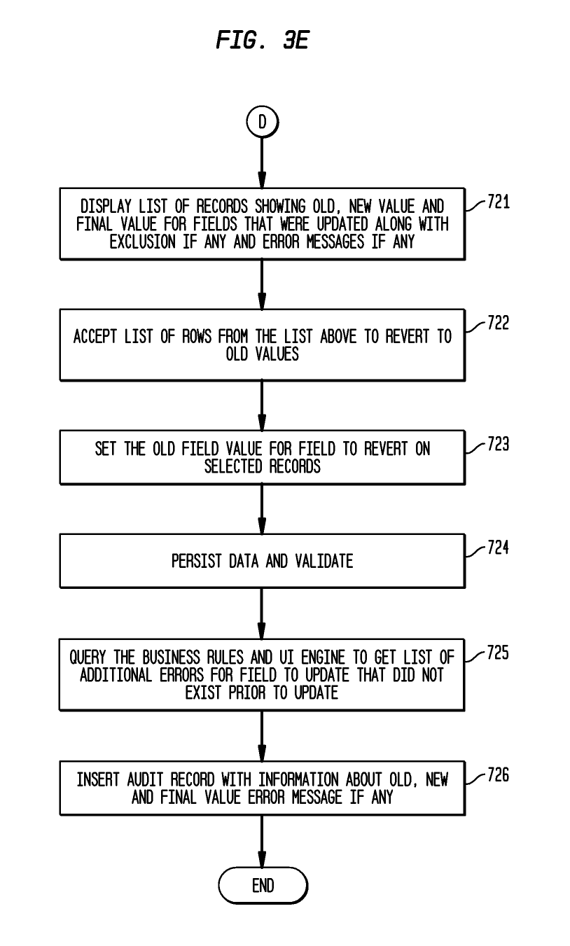

FIGS. 3a-e show flowcharts of the process involved to carry out the mass update. At a high level these steps can be divided into the following 5 phases: search, entry, preview, finalization and reversion.

FIG. 3a shows the process for searching the data model for fields related to the data modification. In step 701, the system will receive a request from a user via a mass update user interface that a mass update is to be performed. The mass update request may include an object that meets specific criteria for allowing a mass update. That is, the criteria may require the request to contain information about a current business object in the hierarchy in the context of which the mass update is to be carried out and that the current business objective is a type that is updatable.

In step 702, using the information from the mass update request, the system will perform a query of the data model (through an application programming interface (API) provided by component, if available) using the mass update information entered by the user. The query will search through all the business objects and the fields related to the queried business object. A list of all relevant business objects and fields is then populated. In step 703, the system will filter (using a user interface component filter) the business objects and fields obtained in step 702 and will retain only the fields which will allow the user to perform a modification. These fields would typically be any field which is visible or conditionally visible to a user when carrying out data entry for the business object, even if such field is not able to be updated by the user.

In step 704, the system will display to the user on a display device a list of fields obtained in step 703. Since the databases are often complicated and contain a lot of fields, an appropriate user interface may be provided to search through the listed fields and the user may adjust the fields so that only fields needed for the modification are displayed. This user interaction may also result into a request to the system to get more information about a displayed field. That is, the user may obtain additional detailed information about the displayed field from other system components, convert the information into a format as needed by the user interface and display this information to the user. Once completed, the user will be able to make corrections to the search criteria and remove any criterion added by mistake. The system may also apply appropriate validation rules based on the field definition as available from the database so that the field validation rules may be enforced. In step 705, the user may accept the list of fields.

FIG. 3b shows the process for entering the modification data in the chosen fields. In step 706, the system will retrieve the object and/or field data for the fields obtained in step 705. In step 707, the user interface component filter will filter the fields and will retain only the fields which the user is allowed to update. These fields would typically be the fields that are defined as being able to be always visible and updatable or conditionally visible and updatable. In step 708, the system will display the list of fields that can be updated. In step 709, the user will specify the fields to update and enter their new values to which they should be updated. An appropriate search mechanism may be provided to allow the user to find the fields to update from all the fields available. As mentioned in 705, 708, the system should also enforce the field validation rules. In addition, the system should not allow the same field to be used more than once and the user should be able to make corrections to the new values specified to remove any field added by mistake. In other words, in step 709, the user will provide the new values for the fields to update and these fields will be subject to validations based on the field information.

FIG. 3c shows the process for previewing the updated fields with a business rule validation report. In step 710, a business rule report is prepared by querying the data model. That is, the system will access all the fields which are to be updated. Once accessed, the system prepares a business rule report containing the fields to be updated, the current value found in the object, the new value for the business object, and if any business rules are to be violated if the change was to take place. The report may be displayed to the user as a list of rows. In step 711, the system will get the list of all the records based on the query built in step 710 and will insert them as an audit of the system before any change takes place. Such audit record will usually contain information such as a list of rows used in a search or an update, the old values of the key columns, searched columns and columns to update and the new value that the user wants to be mass updated.

In step 712, the system may display the list to an end user as a preview of what will happen if the user was to proceed with the mass update by querying the audited information. In step 713, the user may exclude any records that the user does not want mass update even if they fall within search criteria provided. Since the mass update preview may have large number of records, the system may provide a paging/navigation mechanism that will help user during an exclusion process. The user may also rectify any business rule violations that occur by changing the new value of the field into a value that does not violate a business rule. In step 714, the system will maintain an audit of any records that user excludes or changes from the mass update and provide list of records that are to be updated to the user.

FIG. 3d shows the process for finalizing and updating the database. For all the records that are to be mass updated after applying the exclusion, the system will perform steps 715 through 720 in an optimal manner as supported by the APIs of the underlying data model, user interface, business rules, and persistence components.

In step 715, the system will query the list to ensure the fields to be updated are defined as visible or able to be updated based on the business rules. The attributes for each of the rows can vary based on the data for such row. Specifically, when the user submits a request for mass update, the system will get a list of all the fields that are not excluded from mass update and for each field, the system will check the attributes to ensure that the fields are still in a state where the user could have accessed it. If not, the system will skip the update for that field. In step 716, the system will query the business rules and user interface to get a list of existing errors related to the fields that are to be updated. It is important to distinguish these errors from the ones resulting because of the mass update. In step 717, the system will update the fields with the new field value. In step 718, once all of the fields have been processed, the system will save the data and/or perform a final validation. In step 719, the system will query the list of errors associated with fields that were updated and compare these errors with the errors obtained in step 716. The system will then provide the list of new errors to the user, if any. In step 720, the system will insert an audit record for each record updated with information about the old, new and final values that was set in the field and the errors if any resulting because of the update.

FIG. 3e shows the process for reverting the update using the audit, if needed. In step 721, the system will display the list of records as shown in preview stage of the mass update, clearly indicating records that were skipped, new values, and errors if any associated with each record and display to end user. In step 722, after verifying the results and errors associated with the mass update, the user may want to revert some/all of the changes. Using the appropriate user interface, the user selects the list of records that need to be restored to their values before the mass update and maintain such information in session. When user submits a request to revert mass update to selected records, the system will get the list of records to be reverted from mass update from the audited information and information stored in session. In step 723, the system will set the old values for all the records that are to be reverted from mass update. In step 724, the data will be persisted and validated as done during the update in 718. In step 725 and 726, as done in 719 and 720 (517, 518), the system will query the list of new errors and compare them with errors prior to update as found during step 716 to check for any new errors. The system will then audit the information about records reverted, the final values for the fields on these records and errors if any. In step 727, the system will display the results to the end user by querying the audit information. At this point user can close the interface for mass update and see the changes reflected in the main user interface of the application.

For example, using FIG. 2, a user may request that a mass update be performed on the deductible for malpractice insurance for a particular policy. The requestor wants to change the deductible from $1000 to $500. The system will receive this request and will perform a query of the data model using the requested information entered by the user. The query will search through all the business objects in the data model to find the fields related to the requested information. The mass update server will then return to the user a list containing the fields that may be updated. In our example, the list will contain the professional malpractice deductible for New Jersey, New York and Connecticut. The system will then filter these fields and retain the fields to which the user is allowed to make a modification. In this example, the user may modify the deductibles for all three states.

Now the user will be allowed to make corrections to the search criteria to remove any criterion added by mistake. After review, the user accepts the list of fields based on the requested information. The system then retrieves the business objects from the database and again filters the fields excluding fields the user is not allowed to update. Once complete, the user then enters the new values (deductible=$500) associated with the business object. The system then prepares a validation report with a list of business objects found in the search, the current value found in the object, the new value for the object, their relationship to each other and if any business rules were violated. The report is audited and shown to the user for review. At this point, the user may correct any business rules that were violated. For example, a business rule may have stated that the deductible in New York cannot be below $800. The user then may decide to exclude New York from the mass update or change the deductible to $800 so that the business rule is not violated. Once this exclusion or change is made, the user can finalize the updates and apply these changes. The system will then do a final validation and, if no violations are found, the database will be updated and an audit report will be saved. At this point user can close the interface for mass update and see the changes reflected in the main user interface of the application. If the user decides these numbers are not correct, the user may use the reversion process to undo any changes that were made.

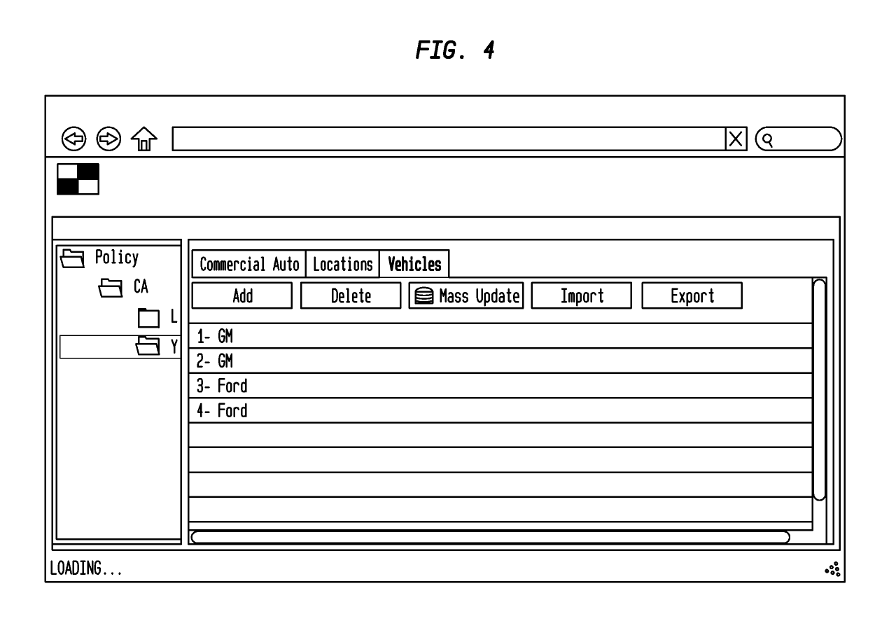

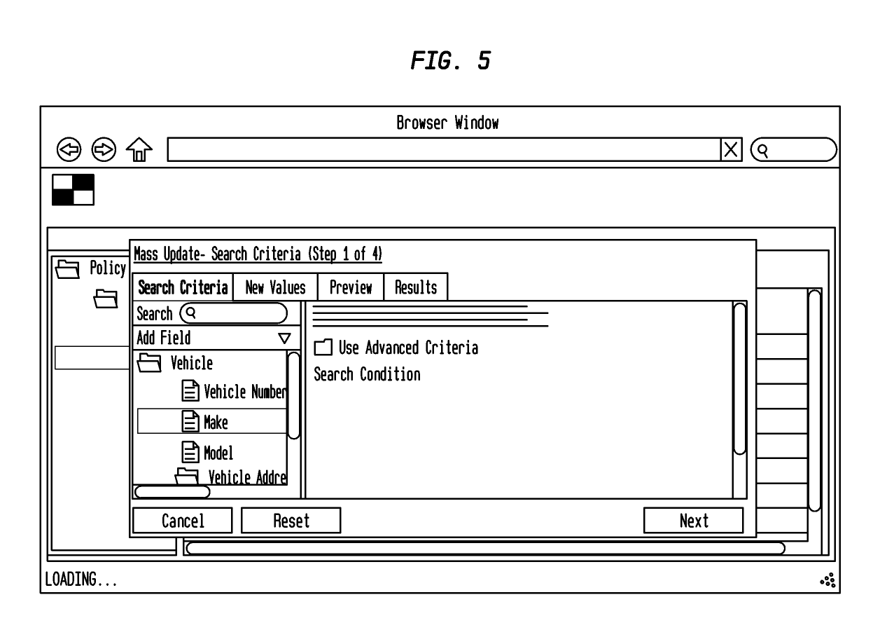

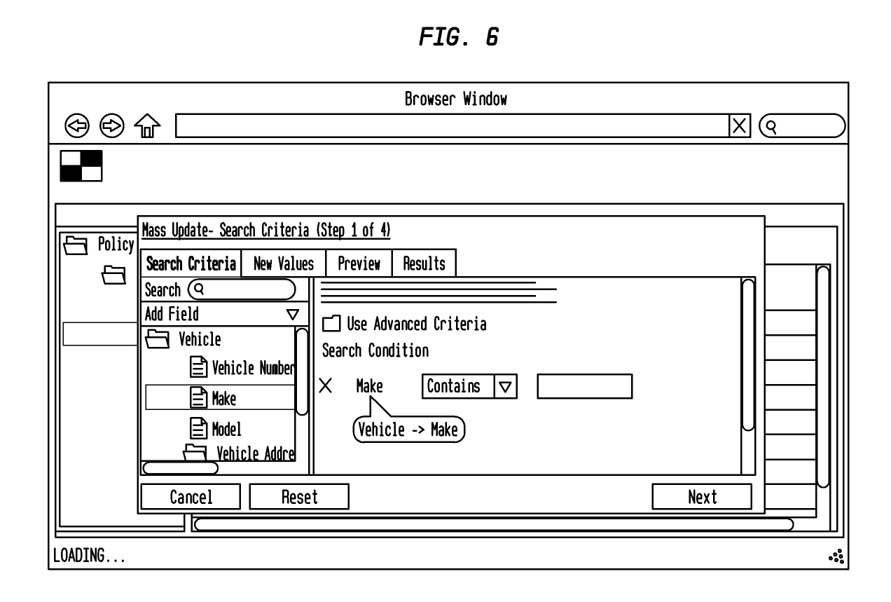

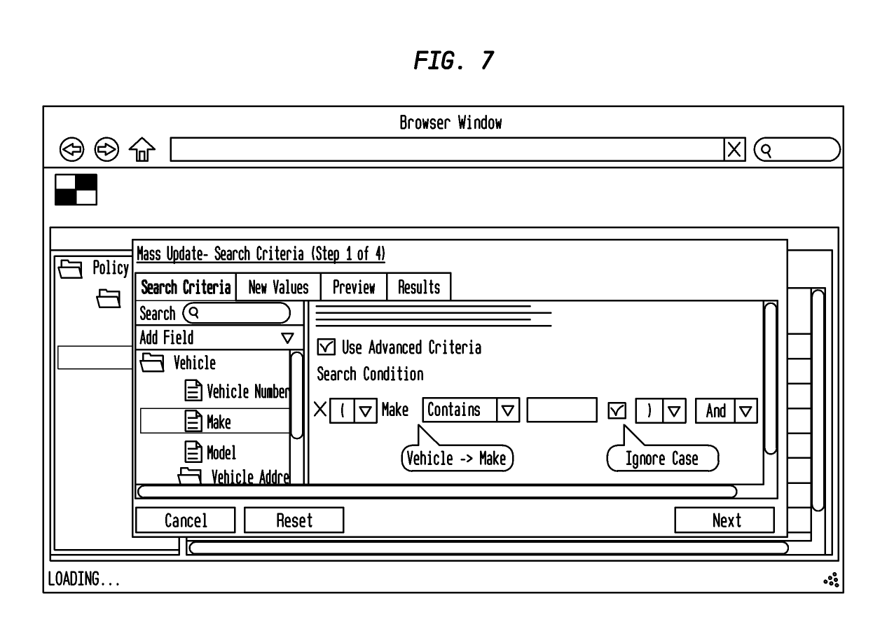

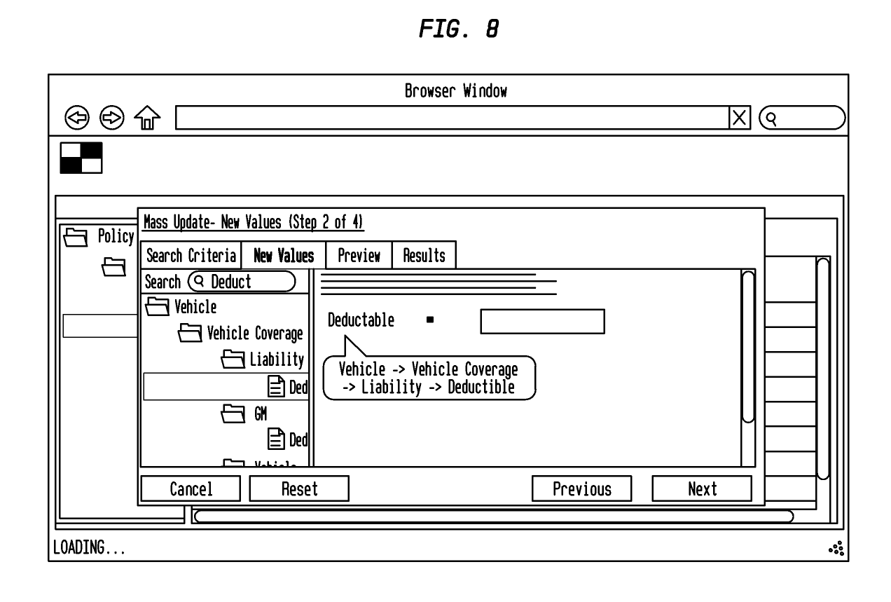

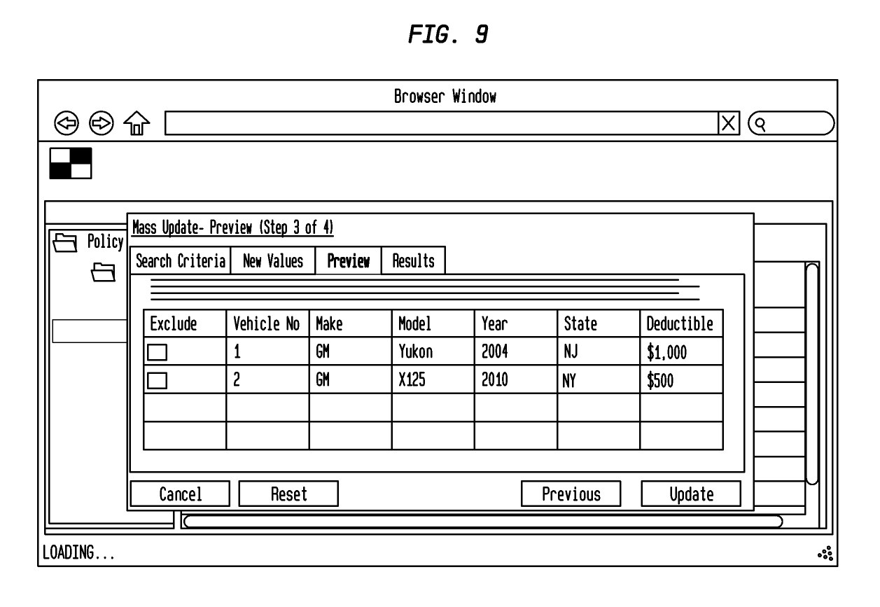

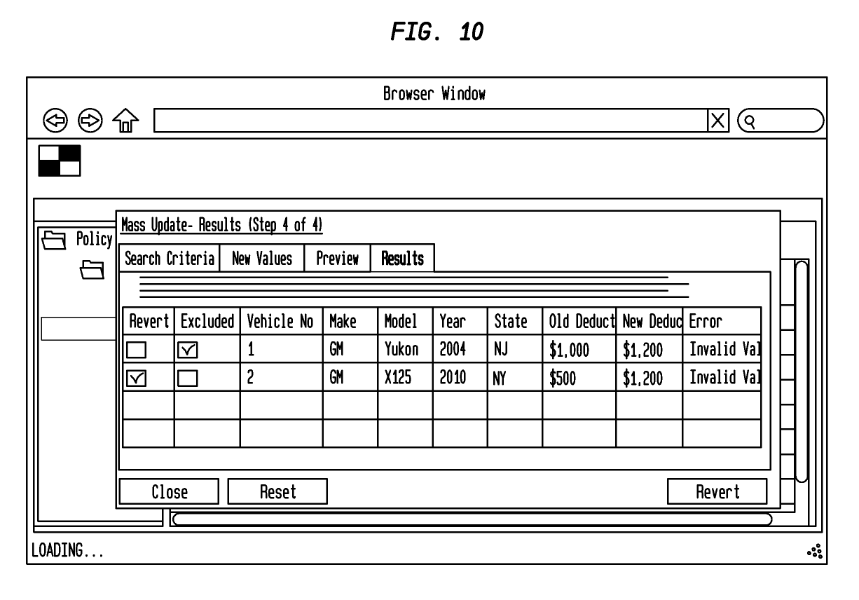

FIGS. 4-10 show screen captures for an implementation of the disclosed technology. This example shows a user changing a deductible for GM vehicles. FIG. 4 shows a displayed data model by presenting object tags on the top portion of the display. The top of the hierarchical order is Policy followed by Commercial Auto followed by Locations and finally Vehicles. Under vehicles the user is shown a list of cars that are insured under this policy. When a user wants to make a mass update to this policy, a user will start the mass update module as shown in FIG. 5. In FIGS. 6-7, the user uses an advanced search function to search the database. In this example, the user wants to make a mass update to the deductible using vehicle make (GM) as the search criteria. Once, the user was satisfied with the search results, the system, in FIG. 6, asked the user to insert the new value for the deductible field. In FIG. 7, the system displayed to the user two vehicles that may be mass updated with the data objects currently associated with these vehicles. In FIG. 8, the system displayed a full validation report to the user showing the old values, the new values and if any business rules may be violated. In this example, the change triggered two errors for both updates. In this instance, the user decided to exclude one update and revert to the old value for the second update. But if the preview revealed no business rule violations, the user could have accepted the changes and applied the changes to the database.

It is noted that the systems and methods disclosed herein may be implemented on various types of computer architectures, such as for example on a single general purpose computer or workstation, or on a network (e.g., local area network, wide area network, or internet), or in a client-server configuration, or in an application service provider configuration. Also, the system's and method's data (such as hierarchical data) may be stored as one or more data structures in computer memory and/or storage depending upon the application at hand. The systems and methods may be provided on many different types of computer readable media including instructions being executable by a computer to perform the system and method operations described herein. The systems and methods may also have their information transmitted via data signals embodied on carrier signals (e.g., radio frequency carrier signals) or other communication pathways (e.g., fiber optics, infrared, etc.).

The computer components, software modules, functions and data structures described herein may be connected directly or indirectly to each other in order to allow the flow of data needed for their operations. It is also noted that a module includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The computer components may be located on a single computer or distributed across multiple computers depending upon the situation at hand.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A computer-implemented method for updating multiple data records in a database in a single transaction, comprising:
searching a data model associated with the data records in the database for fields related to an objective;
entering new objective values associated with the objective;
performing a business rule validation of the fields found during searching step with the new objective values entered;
displaying a report of the business rule validation on a display;
approving the new objective values; and
applying the finalized objective values to the data model.

2. The method of claim 1 wherein the data model is a hierarchical database model.

3. The method of claim 2 wherein the data model contains repeating data elements.

4. The method of claim 1 wherein the objective is a request to update the database with a transaction involving at least one modification across one or more fields.

5. The method of claim 1 wherein the searching step performs a query of the data model using the objective.

6. The method of claim 1 wherein the business rule validation includes applying business rules to the fields found during searching step with the new objective values entered.

7. The method of claim 1 wherein the report includes the fields found during the searching step, the new objective values, previous objective values, and business rules violations, if any.

8. The method of claim 1 wherein a user interface is provided to search through the fields found during the searching step so that the user may adjust the fields as needed.

9. The method of claim 1 wherein the approving step further includes:
rectifying business rule violations by modifying the new objective value into an objective value that does not cause a business rule violation.

10. The method of claim 1 wherein the approving step further includes:
excluding fields a user does not want to mass update due to a business rule violation.

11. The method of claim 1 further comprising:
maintaining a full audit trail of operations performed so that changes may be reverted completely or partially.

12. The method of claim 11 further comprising:
requesting to revert selected fields to original values.

13. A system for analyzing and updating data records in a database, comprising:
one or more processors;
one or more computer-readable storage mediums containing instructions configured to cause the one or more processors to perform operations including:
searching a data model for fields related to an objective;
entering new objective values that are associated with the objective;
performing a business rule validation of the fields found during searching step with the new objective values entered;
displaying a report of the business rule validation on a display;
approving the new objective values; and
applying the finalized objective values to the data model.

14. The system of claim 13 wherein the objective is a request to update the data model with a transaction involving at least one modification across one or more fields.

15. The system of claim 13 wherein the searching step performs a query of the data model using the objective.

16. The system of claim 13 wherein the business rule validation includes applying business rules to the fields found during searching step with the new objective values entered.

17. The system of claim 13 wherein the report includes the fields found during the searching step, the new objective values, previous objective values, and business rules violations, if any.

18. A computer-program product, tangibly embodied in a machine-readable storage medium, including instructions configured to cause a data processing apparatus to:
search a data model for fields related to an objective;
enter new objective values that are associated with the objective;
perform a business rule validation of the fields found during searching step with the new objective values entered;
display a report of the business rule validation on a display;
approve the new objective values; and
apply the finalized objective values to the data model.

19. The computer-program product of claim 18 wherein the objective is a request to update the data model with a transaction involving at least one modification across at least two fields.

20. The computer-program product of claim 18 wherein the searching step performs a query of the data model using the objective.

21. The computer-program product of claim 18 wherein the business rule validation includes applying business rules to the fields found during searching step with the new objective values entered.

22. The computer-program product of claim 18 wherein the report includes the fields found during the searching step, the new objective values, previous objective values, and business rules violations, if any.
